(19) United States
(12) Patent Application Publication
(10) Pub. No.: US 2024/0406702 A1
(43) Pub. Date: Dec. 5, 2024

(54) SENSING OPERATION USING A MOBILE BASE STATION

(71) Applicant: QUALCOMM Incorporated, San Diego, CA (US)

(72) Inventors: Preeti Kumari, San Diego, CA (US); Hong Cheng, Basking Ridge, NJ (US); Kapil Gulati, Belle Mead, NJ (US); Shuanshuan Wu, San Diego, CA (US); Junyi Li, Fairless Hills, PA (US)

(21) Appl. No.: 18/326,646

(22) Filed: May 31, 2023

(51) Int. Cl. H04W 8/00; H04W 48/20

(52) U.S. Cl. CPC H04W 8/005; H04W 48/20

(57) ABSTRACT

This disclosure provides systems, methods, and devices for wireless communication that support a sensing operation. In a first aspect, a network entity is configured to receive a report based on a sensing operation performed by a mobile base station and a user equipment (UE). In a second aspect, a mobile base station is configured to perform a sensing operation between the mobile base station and a UE. In a third aspect, a UE is configured to perform a sensing operation between the UE and a mobile base station. Other aspects and features are also claimed and described.

### TECHNICAL FIELD

Aspects of the present disclosure relate generally to wireless communication systems, and more particularly, to a sensing operation, such as a bistatic sensing operation using a mobile base station. Some features may enable and provide sensing operation management and control, reduced overhead signaling, improved sensing performance, high target detection performance, high target parameter estimation performance, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Conventional 3GPP systems are configured to utilize a mobile base station to a limited extent, such as use as a mobile relay in vehicular communication applications. The limited utilization of mobile base stations by the conventional 3GPP systems presents an opportunity to identify further uses and application of the mobile base station, such as uses for 5G or 6G communication.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication performed by a network entity includes transmitting, to a mobile base station, configuration information for a first sensing operation associated with a user equipment (UE). The method further includes receiving a first report based on the first sensing operation, the first sensing operation performed by the mobile base station and the UE.

In an additional aspect of the disclosure, a base station includes a memory storing processor-readable code, and at least one processor coupled to the memory. The at least one processor is configured to execute the processor-readable code to cause the at least one processor to transmit, to a mobile base station, configuration information for a first sensing operation associated with a UE. The at least one processor is further configured to execute the processor-readable code to cause the at least one processor to receive a first report based on the first sensing operation, the first sensing operation performed by the mobile base station and the UE.

In an additional aspect of the disclosure, an apparatus includes means for transmitting, to a mobile base station, configuration information for a first sensing operation associated with a UE. The apparatus further includes means for receiving a first report based on the first sensing operation, the first sensing operation performed by the mobile base station and the UE.

In an additional aspect of the disclosure, a non-transitory computer-readable medium stores instructions that, when executed by a processor, cause the processor to perform operations. The operations include transmitting, to a mobile base station, configuration information for a first sensing operation associated with a user equipment (UE). The operations further include receiving a first report based on the first sensing operation, the first sensing operation performed by the mobile base station and the UE.

In an additional aspect of the disclosure, an apparatus includes at least one processor coupled to a memory storing processor-readable code. The at least one processor is configured to execute the processor-readable code to cause the at least one processor to generate configuration information for a first sensing operation associated with a UE. The apparatus further includes a communication interface configured to transmit, to a mobile base station, the configuration information. The communication interface is further configured to receive a first report based on the first sensing operation, the first sensing operation performed by the mobile base station and the UE.

In one aspect of the disclosure, a method for wireless communication performed by a mobile base station includes receiving, from a network entity, configuration information for a first sensing operation associated with a UE. The method further includes performing the first sensing operation with the UE.

In an additional aspect of the disclosure, a base station includes a memory storing processor-readable code, and at least one processor coupled to the memory. The at least one processor is configured to execute the processor-readable code to cause the at least one processor to receive, from a network entity, configuration information for a first sensing operation associated with a UE. The at least one processor is further configured to execute the processor-readable code to cause the at least one processor to perform, by a mobile base station, the first sensing operation with the UE.

In an additional aspect of the disclosure, an apparatus includes means for receiving, from a network entity, configuration information for a first sensing operation associated with a UE. The apparatus further includes means for performing, by a mobile base station, the first sensing operation with the UE.

In an additional aspect of the disclosure, a non-transitory computer-readable medium stores instructions that, when executed by a processor, cause the processor to perform operations. The operations include receiving, from a network entity, configuration information for a first sensing operation associated with a UE. The operations further include performing, by a mobile base station, the first sensing operation with the UE.

In an additional aspect of the disclosure, an apparatus includes a communication interface configured to receive, from a network entity, configuration information for a first sensing operation associated with a UE. The apparatus further includes at least one processor coupled to a memory storing processor-readable code. The at least one processor is configured to execute the processor-readable code to cause the at least one processor to configure, based on the configuration information, a mobile base station for the first sensing operation with the UE.

In one aspect of the disclosure, a method for wireless communication performed by a UE includes receiving, from a network entity, configuration information for a first sensing operation associated with a mobile base station. The method also includes performing the first sensing operation with the mobile base station.

In an additional aspect of the disclosure, a UE includes a memory storing processor-readable code, and at least one processor coupled to the memory. The at least one processor is configured to execute the processor-readable code to cause the at least one processor to receive, from a network entity, configuration information for a first sensing operation associated with a mobile base station. The at least one processor is further configured to execute the processor-readable code to cause the at least one processor to perform the first sensing operation with the mobile base station.

In an additional aspect of the disclosure, an apparatus includes means for receiving, from a network entity, configuration information for a first sensing operation associated with a mobile base station. The apparatus further includes means for performing the first sensing operation with the mobile base station.

In an additional aspect of the disclosure, a non-transitory computer-readable medium stores instructions that, when executed by a processor, cause the processor to perform operations. The operations include receiving, from a network entity, configuration information for a first sensing operation associated with a mobile base station. The operations further include performing the first sensing operation with the mobile base station.

In an additional aspect of the disclosure, an apparatus includes a communication interface configured to receive, from a network entity, configuration information for a first sensing operation associated with a mobile base station. The apparatus further includes at least one processor coupled to a memory storing processor-readable code. The at least one processor is configured to execute the processor-readable code to cause the at least one processor to perform the first sensing operation with the mobile base station.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports a sensing operation according to one or more aspects.

FIG. 5 is a ladder diagram illustrating an example of a sensing operation according to one or more aspects

FIG. 6 is a ladder diagram illustrating an example of a sensing operation according to one or more aspects

FIG. 7 is a flow diagram illustrating an example process that supports a sensing operation according to one or more aspects.

FIG. 8 is a block diagram of an example UE that supports a sensing operation according to one or more aspects.

FIG. 9 is a flow diagram illustrating an example process that supports a sensing operation according to one or more aspects.

FIG. 10 is a flow diagram illustrating an example process that supports a sensing operation according to one or more aspects.

FIG. 11 is a block diagram of an example network entity that supports a sensing operation according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support a sensing operation. For example, the present disclosure describes enabling a sensing operation, such as bistatic sensing operation, that is performed using mobile base station. A user equipment (UE) may be configured to perform a sensing operation, such as a bistatic sensing operation, with a network entity. The network entity may include a base station, such as a fixed base station, that is configured as a serving base station of the UE. In some implementations, to perform the sensing operation, the UE is configured as a transmit (Tx) node and the network entity is configured as a receive (Rx) node and, in other implementations, the UE is configured as the Rx node and the network entity is configured as the Tx node. The sensing operations may be unsuccessful due to a blockage, a distance between the UE and the network entity, or another reason. Based on the unsuccessful sensing operation, the network entity may select a mobile base station to perform the sensing operation with the UE. For example, the mobile base station may receive configuration information from the network entity to configure the mobile base station as the Tx node or the Rx node to perform the sensing operation. Based on the sensing operation performed by the mobile base station and the UE, the network entity may receive a report, such as a measurement report from the UE, the network entity, or both. Based on the report, the network entity may detect an object or track a target. For example, the network entity may detect an object or track the target based on the report.

Particular implementations of the subject matter described in this disclosure may be implemented to realize one or more of the following potential advantages or benefits. In some aspects, the present disclosure provides techniques for supporting a sensing operation. The techniques described enable a sensing operation, such as bistatic sensing operation, that is performed using one or more mobile base stations, such as the mobile base station. The mobile base station may advantageously be used for the sensing operation in one or more situations, such as when the UE is a Tx node and the network entity is an Rx node, or when the UE is an Rx node and the network entity is an Tx node, and performance of the sensing operation is limited due to a blockage or a distance between the UE and the network entity. Use of the mobile base station for the sensing operation may enable improved sensing performance, high target detection performance, high target parameter estimation performance, or a combination thereof.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

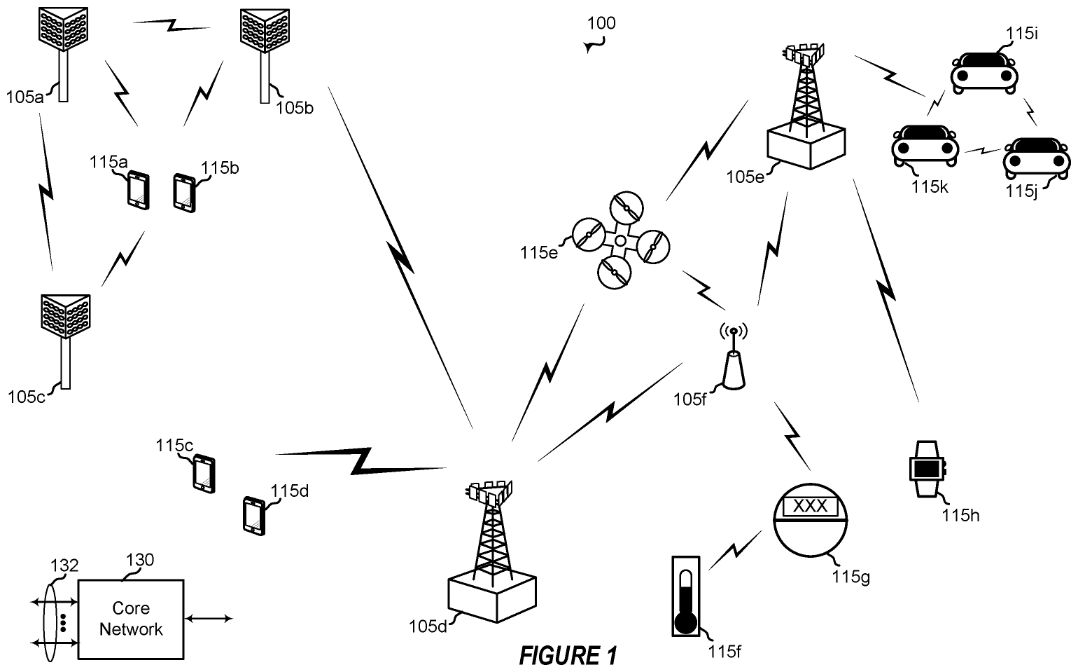

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a management function, such as a Location Management Function (LMF) or a Sensing Management Function (SnMF), which is an entity in the 5G Core Network (5GC) supporting various functionality, such as managing support for different location services for one or more UEs. The SnMF may be configured to manage support for sensing operations for one or more sensing operations or sensing services for one or more devices, such as one or more UEs 115, one or more base stations 105, one or more TRPs, or a combination thereof. For example the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. The LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via an Access and Mobility Management Function (AMF).

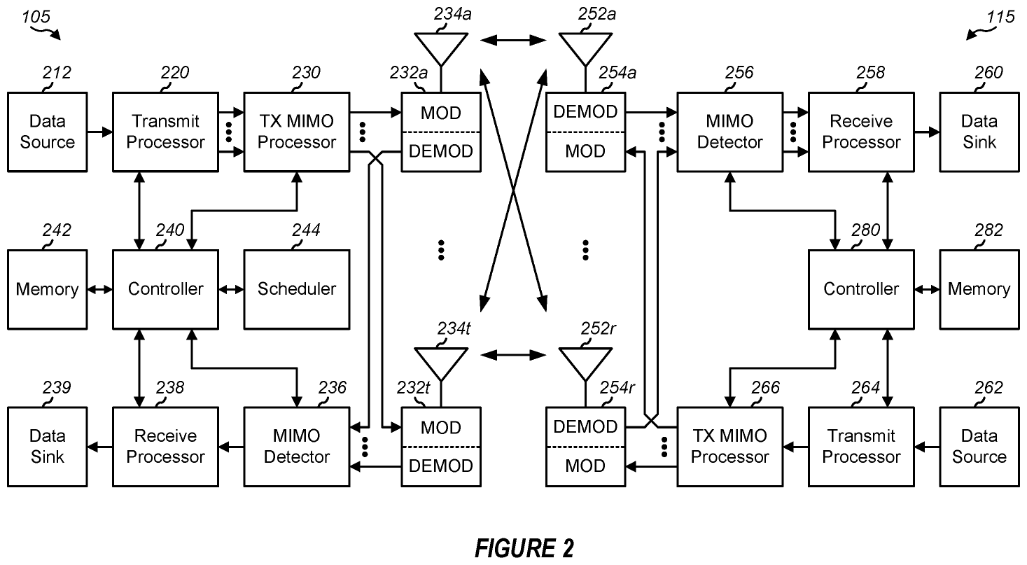

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

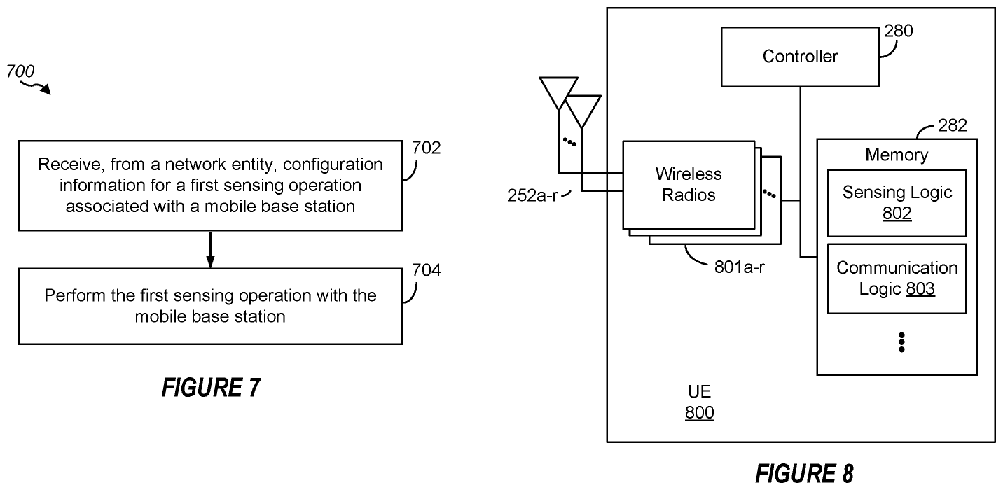

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 7, 9, and 10, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

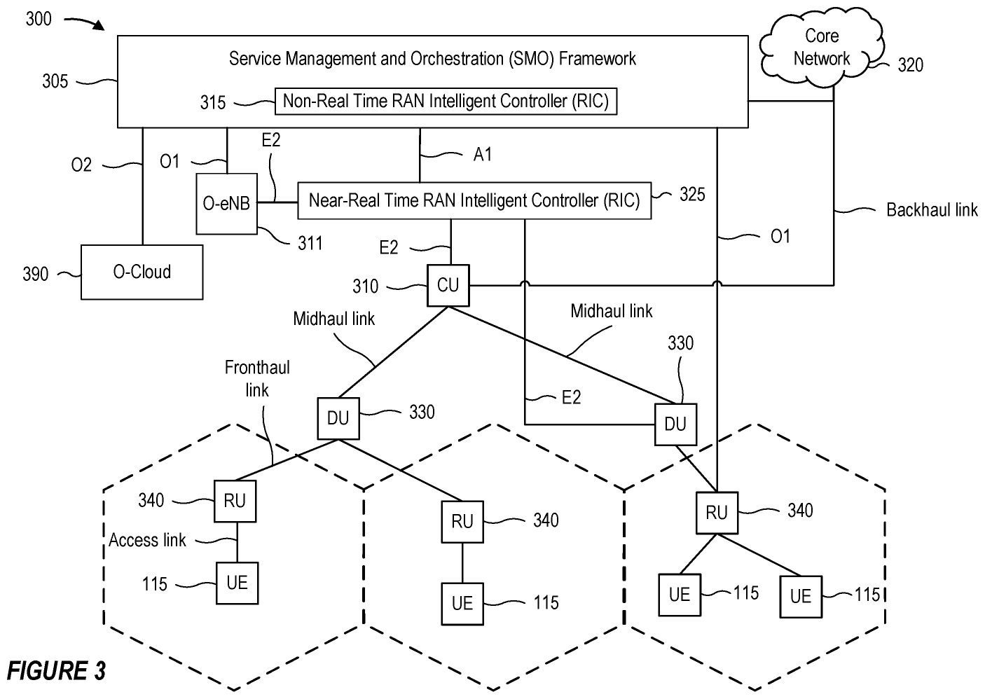

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 115 via one or more radio frequency (RF) access links. In some implementations, UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

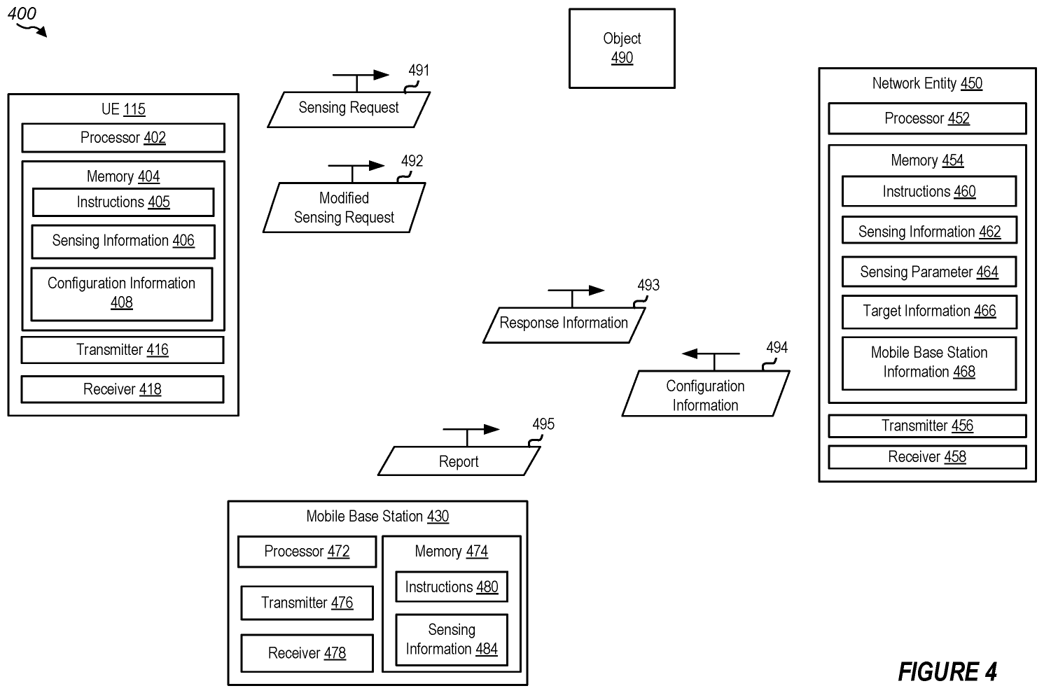

FIG. 4 is a block diagram of an example wireless communications system 400 that supports a sensing operation according to one or more aspects. In some examples, wireless communications system 400 may implement aspects of wireless network 100. Wireless communications system 400 includes UE 115, a network entity 450, and a mobile base station 430. Although one UE 115, one network entity 450, and one mobile base station 430 are illustrated, in some other implementations, wireless communications system 400 may generally include multiple UEs 115, multiple network entities 450, multiple mobile base stations 430, or a combination thereof.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). In some implementations, UE 115 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405, sensing information 406, and configuration information. Instructions 405 may include processor-readable code, program code, one or more software instructions, or the like, as illustrative, non-limiting examples. Sensing information 406 may include or indicate one or more measurements or results of a sensing operation. Additionally, or alternatively, sensing information may include or indicate a transmit power, a reference signal received strength, a resource, a resource pool, a bandwidth, a sensing quality of service, a mode of operation (e.g., bistatic or monostatic), a sensing time period or time domain, a beam direction, a beam bandwidth, a location of an object (e.g., 490), or a combination thereof. Configuration information 408 may include or indicate one or more parameters or settings associated with a sensing operation. The one or more parameters may include or indicate one or more sensing parameters, a Tx node configuration, an Rx node configuration, a scanning mode operation, a tracking mode operation, a location of mobile base station 430, a mobility of mobile base station 430, or a combination thereof. Additionally, or alternatively, configuration information 408 may include or indicate a number of radar beams, a beamwidth for each beam, a pointing direction for each beam, a mode, or a combination thereof. The mode may include or indicate a joint communication sensing mode, a communication mode, or a sensing mode, as illustrative, non-limiting examples.

Transmitter 416 is configured to transmit reference signals (e.g., sensing signals), control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105, network entity 450, mobile base station 430, or another UE. In some implementations, transmitter 416 and receiver 418 may be integrated in one or more transceivers. Additionally or alternatively, transmitter 416 or receiver 418 may include or correspond to one or more components of UE 115 described with reference to FIG. 2.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, UE 115 may include a sensing device. The sensing device may be configured to be used in a monostatic sensing operation or a bistatic sensing operation. Additionally, or alternatively, the sensing device may be associated with a joint communication and radar (JCR) system. The JCR system may be categorized as a cooperative JCR system or a co-design of communication and radar systems. For example, the sensing device may be associated with the co-design of communication and radar systems. In some implementations, the sensing device is configured for two-stage UL sensing, such as a scanning phase and a tracking phase. In some implementations, sensing device includes transmitter 416, receiver 418, a communication interface, or a combination thereof. Although described as including both transmitter 416 and receiver 418, in other implementations, the sensing device may include transmitter 416 but not receiver 418, or may include receiver 418 but not transmitter 416. In some implementations, UE 115 is a 5G-capable UE, a 6G-capable UE, or a combination thereof.

Network entity 450 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, network entity 450 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store instructions 460, sensing information 462, sensing parameter 464, target information 466, and mobile base station information 468. Instructions 460 may include processor-readable code, program code, one or more software instructions, or the like, as illustrative, non-limiting examples.

Sensing information 462 may include or indicate one or more measurements or results of a sensing operation. Sensing information may include or correspond to sensing information 406. Sensing parameter 464 may include or indicate a sensing key performance indicator (KPI), a quality of service (QOS) requirement, or a combination thereof. The KPI may include range coverage, field of view, range resolution, angular resolution, velocity resolution, accuracy, probability of detection, latency, refresh rate, number of simultaneous targets, or a combination thereof, as illustrative, non-limiting examples. Target information 466 may include or indicate a target parameter associated with a detected object or an object to be tracked. The target parameter may include or indicate a position, a velocity, or a combination thereof of the detected target or the object to be tracked. Mobile base station information 468 may include or indicate a capability of mobile base station 430, a location of mobile base station 430, a mobility (e.g., one or more mobility parameters) of mobile base station 430, sensing charge information (sensing charging fee/rules) of mobile base station 430, a sensing measurement rereport of a pre-sensing operation by the mobile base station 430, or a combination thereof.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2.

In some implementations, network entity 450 may include one or more antenna arrays. The antenna array may include multiple antenna elements configured to perform wireless communications with other devices, such as with UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, network entity 450 may include a sensing device. The sensing device may be configured to be used in a monostatic sensing operation or a bistatic sensing operation. Additionally, or alternatively, the sensing device may be associated with a joint communication and radar (JCR) system. The JCR system may be categorized as a cooperative JCR system or a co-design of communication and radar systems. For example, the sensing device may be associated with the co-design of communication and radar systems. In some implementations, the sensing device is configured for two-stage UL sensing, such as a scanning phase and a tracking phase. In some implementations, sensing device includes transmitter 456, receiver 458, a communication interface, or a combination thereof. Although described as including both transmitter 456 and receiver 458, in other implementations, the sensing device may include transmitter 456 but not receiver 458, or may include receiver 458 but not transmitter 456.

Mobile base station 430 may include a variety of components (such as structural, hardware components) used for carrying out one or more functions described herein. For example, these components may include one or more processors 472 (hereinafter referred to collectively as “processor 472”), one or more memory devices 474 (hereinafter referred to collectively as “memory 474”), one or more transmitters 476 (hereinafter referred to collectively as “transmitter 476”), and one or more receivers 478 (hereinafter referred to collectively as “receiver 478”). In some implementations, mobile base station 430 may include an interface (e.g., a communication interface) that includes transmitter 476, receiver 478, or a combination thereof. Processor 472 may be configured to execute instructions 480 stored in memory 474 to perform the operations described herein. In some implementations, processor 472 includes or corresponds to one or more of receive processor 238, transmit processor 220, and controller 240, and memory 454 includes or corresponds to memory 242.

Memory 474 includes or is configured to store instructions 480 and sensing information 484. Instructions 480 may include processor-readable code, program code, one or more software instructions, or the like, as illustrative, non-limiting examples. Sensing information 484 may include or indicate one or more measurements or results of a sensing operation. Sensing information 484 may include or correspond to sensing information 406 or 462.

Transmitter 476 is configured to transmit reference signals, synchronization signals, control information and data to one or more other devices, and receiver 478 is configured to receive reference signals, control information and data from one or more other devices. For example, transmitter 476 may transmit signaling, control information and data to, and receiver 478 may receive signaling, control information and data from, UE 115 or network entity 450. In some implementations, transmitter 476 and receiver 478 may be integrated in one or more transceivers. Additionally or alternatively, transmitter 476 or receiver 478 may include or correspond to one or more components of base station 105 described with reference to FIG. 2.

In some implementations, mobile base station 430 may include one or more antenna arrays. The antenna array may include multiple antenna elements configured to perform wireless communications with other devices, such as with UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, mobile base station 430 may include a sensing device. The sensing device may be configured to be used in a monostatic sensing operation or a bistatic sensing operation. Additionally, or alternatively, the sensing device may be associated with a joint communication and radar (JCR) system. The JCR system may be categorized as a cooperative JCR system or a co-design of communication and radar systems. For example, the sensing device may be associated with the co-design of communication and radar systems. In some implementations, the sensing device is configured for two-stage UL sensing, such as a scanning phase and a tracking phase. In some implementations, sensing device includes transmitter 476, receiver 478, a communication interface, or a combination thereof. Although described as including both transmitter 476 and receiver 478, in other implementations, the sensing device may include transmitter 476 but not receiver 478, or may include receiver 478 but not transmitter 476.

In some implementations, wireless communications system 400 may include an object 490, such as a stationary object or a mobile object. Object 490 may be sensed by a device, such as UE 115, network entity 450, mobile base station 430, or a combination thereof, based on one or more sensing operations. The one or more sensing operations may include a monostatic sensing operation or a bistatic sensing operation, as illustrative, non-limiting examples. In some implementations, the one or more sensing operations may be performed to detect object 490, determine a location of object 490, track object 490, or a combination thereof.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP. The multiple 5G-capable base stations 105 may include mobile base station 430, network entity 450, or both. In some other implementations, wireless communications system 400 implements a 6G network.

In some implementations, network entity 450 is configured to perform a mobile base station handover for a mobile base station (e.g., 430) within a coverage area of network entity 450. In some implementations, execution of the mobile base station handover by network entity 450 may be based on a location (actual or estimated) of the mobile base station, a mobility (actual or estimated) of the mobile base station, or a combination thereof. Additionally, or alternatively, execution of the mobile base station handover by network entity 450 may be based on a sensing measurement report from an Rx node.

During operation of wireless communications system 400, UE 115 may transmit a sensing request 491 to network entity 450. Sensing request 491 may be associated with a sensing operation, such as a bistatic sensing operation. Sensing request 491 may include or indicate a parameter associated with the sensing operation. The parameter may include or correspond to sensing information 462. For example, the parameter may include a KPI, a QoS, or a combination thereof. In some implementations, sensing request 491 may indicate that UE 115 requests to be configured as an Rx node for the sensing operations. In other implementations, sensing request 491 may indicate that UE 115 is requests to be configured as a Tx node for the sensing operations.

Network entity 450 may receive sensing request 491 and may allocated or configure one or more sensing resources for the sensing operation. In some implementations, network entity 450 may transmit configuration information 408 to UE 115 to enable UE 115 to perform the sensing operation, such as a bistatic sensing operation performed with network entity 450.

UE 115 and network entity 450 may attempt to perform the sensing operation. If UE 115 is configured as a Tx node, UE 115 transmits a sensing signal as part of the sensing operation and network entity 450 monitors a channel for receipt of the sensing signal. Network entity 450 may determine whether or not the received sensing signal satisfies one or more sensing parameters (e.g., requirements), such as the KPI, the QoS, or a combination thereof, as illustrate, non-limiting examples. If the received sensing signal satisfies the one or more sensing parameters, network entity 450 may further process the sensing signal. Alternatively, if the received signal does not satisfy the one or more sensing parameters, network entity 450 may probe one or more mobile base stations to assist UE 115 with the sensing operation.

If UE 115 is configured as an Rx node, network entity 450 transmits the sensing signal as part of the sensing operation and UE 115 monitors the channel for receipt of the sensing signal. If UE 115 does not receive the sensing signal within a time period, UE 115 may transmit a modified sensing request 492 for performing the sensing operation, such as a request to re-perform the sensing operation or a request to use a mobile base station to perform the sensing operation with UE 115. If UE receives the sensing signal, UE 115 may determine whether or not the received sensing signal satisfies one or more sensing parameters (e.g., requirements), such as the KPI, the QoS, or a combination thereof, as illustrate, non-limiting examples. If the received sensing signal satisfies the one or more sensing parameters, UE 115 may generate a report 495, such as a measurement report, based on the sensing operation and transmit report 495 to network entity 450. Alternatively, if the received signal does not satisfy the one or more sensing parameters, UE 115 may generate and transmit modified sensing request 492, report 495, or a combination thereof. Bases on modified sensing request 492, report 495, or a combination thereof, network entity 450 may probe one or more mobile base stations to assist UE 115 with the sensing operation or may access mobile base station information 468 to identify a mobile base station to assist UE 115.

In some implementations, the sensing signal may be reflected off of object 490 prior to receipt by network entity 450 or UE 115. In other implementations, the sensing signal may be blocked by object 490 or mobile base station 430 and may not be received by network entity 450 or UE 115.

Network entity 450 may probe a set of mobile base stations (e.g., 430) for availability to assist UE 115 with the sensing operation. To probe the set of mobile base stations, network entity may transmit an information request. In some implementations, the information request indicates a channel associated with the sensing operation, one or more parameters or settings associated with the sensing request, or a combination thereof.

For each mobile base station of the set of mobile base stations that receives the information request, the mobile base station (e.g., 430) may transmit response information 493 based on the information request. Response information 493 from mobile base station 430 may indicate a capability of the mobile base station, location of the mobile base station, a mobility of the mobile base station, sensing charge information (e.g., cost information) of the mobile base station, a sensing measurement report of a pre-sensing operation by the mobile base station, or a combination thereof. In some implementations, response information 493 from mobile base station 430 may include or be a capability report of mobile base station 430. Network entity 450 may receive response information 493 and may store response information 493 as mobile base station information 468.

In some implementations, based on the information request, mobile base station 430 may perform a pre-sensing operation. The pre-sensing operation may include a coarse sensing estimation operation with low resource usage overhead, a fine sensing estimation operation within a short duration, or a combination thereof. The pre-sensing operation may provide mobile base station 430 with an understanding the channel between UE 115 and network entity 450. In some implementations, the pre-sensing operation includes a monostatic sensing operation or mobile base station 430 may operate as an Rx node and monitor the channel.

Network entity 450 may select one or more mobile base stations from the set of mobile base stations for the sensing operation (e.g., the bistatic sensing operation) with UE 115. For example, network entity 450 may select one or more mobile base stations based on response information 493, mobile base station information 468, or a combination thereof. Additionally, or alternatively, network entity 450 may select one or more mobile base stations based on an area of interest, a location of UE 115, a location of one or more targets, or a combination thereof. In some implementations, the one or more selected mobile base stations include mobile base station 430.

Based on selection of the one or more mobile base stations, network entity 450 transmits configuration information 494 to mobile base station 430 to configured mobile base station to perform the sensing operation with UE 115. In some implementations, network entity 450 also sends configuration information 494 to UE 115. Configuration information 494 may include or indicate one or more sensing parameters, a Tx node configuration, an Rx node configuration, a location of mobile base station 430, a mobility of mobile base station 430, or a combination thereof, as illustrative, non-limiting examples. In some such implementations, configuration information 494 sent to UE 115 may include or indicate a location of mobile base station 430, a mobility of mobile base station 430, or a combination thereof.

Alternatively, selection of mobile base station 430, configuration information 494 sent to mobile base station 430, or a combination thereof, may be transparent to UE 115. For example, when UE 115 is configured as an Rx node for the sensing operation, UE 115 may not need to know the configuration information, location of mobile base station 430, or a combination thereof. As another example, when UE 115 is configured as an Tx node for the sensing operation, UE 115 may not need to know where an Rx node of the sensing operation is located. To illustrate, Rx processing of a sensing signal transmitted by the Tx node may be performed at the Rx node (e.g., mobile base station 430) based on Tx waveform or beam information, a position of UE 115, a velocity of UE 115, or a combination thereof. The Tx waveform or beam information, a position of UE 115, a velocity of UE 115, or a combination thereof, may be provided to mobile base station 430 by network entity 450 as part of configuration information 494. Additionally, or alternatively, network entity 450 may be configured to perform Rx processing of the sensing signal transmitted by the Tx node based on sensing information received from UE 115 and mobile base station 430.

UE 115 and mobile base station 430 may perform the sensing operation. Based on the performance of the sensing operation, UE 115, mobile base station 430, or both, may generate and transmit a report, such as a report 495. To illustrate, UE 115 may generate report 495 (e.g., a measurement report) and transmit report 495 to network entity 450, mobile base station 430, or a combination thereof.

Network entity 450 may receive one or more reports (e.g., 495) and, based on the one or more reports, may detect object 490 or track one or more targets. In some implementations, network entity 450 may transmit an indicator that indicates a location of object 490 or a target, a velocity of object 490 or the target, or a combination thereof. For example, network entity 450 may transmit the indicator to UE 115, mobile base station 430, core network 130, or a combination thereof.

Although described as request from UE 115, in other implementations, request can come from mobile base station 430. Mobile base station 430 can be a Tx node or an Rx node for a sensing operation, such as a bistatic sensing operation. Mobile base station 430 may perform one or more operations as described with reference to UE 115 to perform the sensing operation with network entity 450, a UE (e.g., 115), another mobile base station, or a combination thereof. Additionally, or alternatively, although one or more operations have been described with reference to network entity 450, in some implementations, at least one operation described with reference to network entity 450 may be performed by core network 130. In some such implementations, information or data may be communicated to or from core network 130 to enable core network to perform the at least one operation and to enable one or more subsequent operations or communication as described herein.

As described with reference to FIG. 4, the present disclosure provides techniques for supporting a sensing operation. The techniques described enable a sensing operation, such as bistatic sensing operation using one or more mobile base stations, such as mobile base station 430. Mobile base station 430 may advantageously be used for the sensing operation in one or more situations, such as when UE 115 is a Tx node and network entity 450 is an Rx node, or when UE 115 is an Rx node and network entity 450 is an Tx node, and performance of the sensing operation is limited due to a blockage or a distance between UE 115 and network entity 450. Use of mobile base station 430 for the sensing operation may enable improved sensing performance, high target detection performance, high target parameter estimation performance, or a combination thereof.

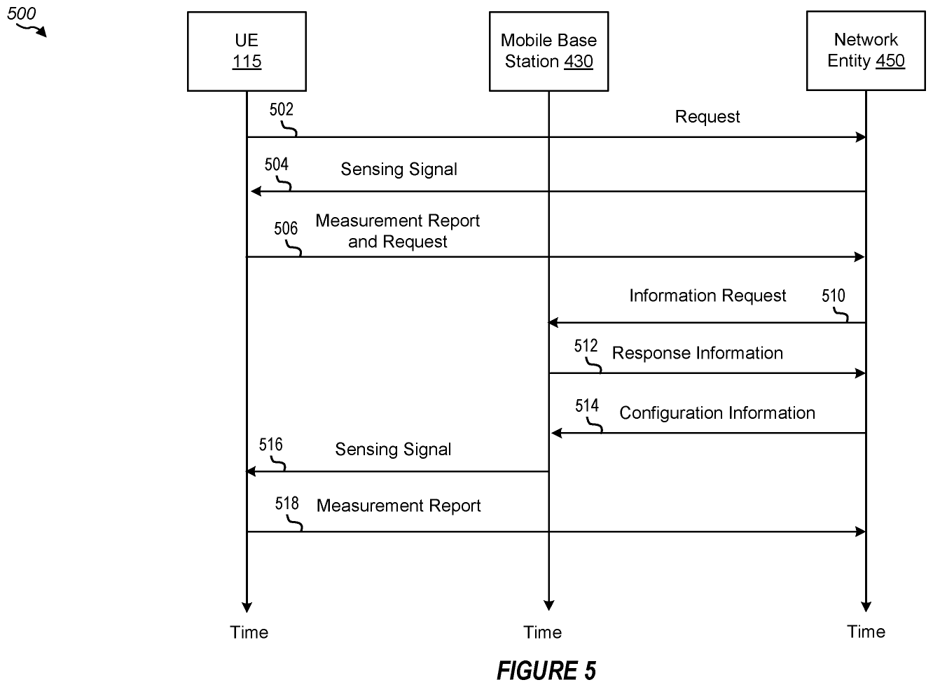

FIG. 5 is ladder diagram illustrating an example of a sensing operation according to aspects of the present disclosure. As shown in FIG. 5, a wireless communication system 500 of the ladder diagram of FIG. 5 includes UE 115, mobile base station 430, and network entity 450. Wireless communication system 500 may include or correspond to wireless communication system 100 or 400. While FIG. 5 depicts singular mobile base station 430, wireless communication system 500 may include multiple mobile base stations. Additionally, although wireless communication system 500 does not show an object, (e.g., 490), in other implementation, wireless communication system 500 may include one or more objects. In some implementations, one or more operations performed or descried with respect to network entity may be performed by a controller, such as a centralized controller (e.g., core network 130 or a management function of core network).

During operation of system 500, at 502, UE 115 transmits a request to perform a sensing operation to network entity 450. In some implementations, network entity 450 is a base station (e.g., a fixed base station). For example, the request may include or correspond to sensing request 491. In some implementation, the request may request network entity 450 to assist in a bistatic sensing operation in which UE 115 is a Rx node. Additionally, or alternatively, the request may request network entity 450 to participate in the sensing operation as a Tx node. In some implementation, the request may include a parameter, such as a sensing KPI, a QoS requirement, or a combination thereof. The parameter may include or correspond to sensing parameter 464.

Based on the request, network entity 450 may grant one or more resources for performing the sensing operation. In some implementations, to grant the one or more resource, network entity 450 may generate or transmit configuration information to UE 115. The configuration information may include or correspond to configuration information 408 or 494.

At 504, network entity 450 transmits a sensing signal. UE 115 may receive the sensing signal, such as a reflection of the sensing signal that is reflected off of an object (e.g. 490). UE 115 may determine sensing information 406 based on the received sensing signal.

At 506, UE 115 transmits a measurement report, a request, or a combination thereof. For example, the measurement report may include or correspond to report 495. The request may include or correspond to modified sensing request 492, or vice versa.

In some implementations, UE 115 waits for a time period to receive the sensing signal from network entity 450. UE 115 may send the request, at 506, if the sensing signal at 504 is not received during the time period. Alternatively may send the request, at 506, if the sensing signal at 504 is insufficient for target detection, insufficient for target estimation, does not satisfy the parameter, or a combination thereof.

Based on receiving the request at 506, network entity 450 selects mobile base station 430 to assist UE 115 with a sensing operation. In some implementation, network entity 450 selects mobile base station 430 from a set of multiple base stations. To select mobile base station 430 from the set of multiple base stations, network entity 450 may probe the set of mobile base stations. For example, network entity 450 probe the set of mobile base stations in response to receiving the request or may have previously provided the set of mobile base stations prior to receiving the request at 506.

To probe the set of mobile base stations, such as mobile base station 430, network entity 450 transmits an information request at 510. At 512, mobile base station 430 transmits response information 512. For example, the response information may include or correspond to response information 493, mobile base station information 468, or a combination thereof. Mobile base station 430 may transmit the response information in response to the information request. The response information may include or indicate a capability of mobile base station 430, a location of mobile base station 430, a mobility (e.g., one or more mobility parameters) of mobile base station 430, sensing charge information (sensing charging fee/rules) of mobile base station 430, a sensing measurement rereport of a pre-sensing operation by the mobile base station 430, or a combination thereof. The response information, at 512, may be transmitted to UE 115, network entity 450, or a combination thereof.

In some implementations, prior to or in response to receiving the information request, mobile base station 430 may perform a pre-sensing operation, such a pre-sensing operation to determine information associated with the response information, a suitability of the mobile base station 430 for use in a sensing operation (e.g., a bistatic sensing operation), or a combination thereof. To illustrate, pre-sensing operation may be performed using a channel associated with UE 115 and network entity 450 for the sensing signal at 504. In some implementations, the pre-sensing operation may monitor for the sensing signal at 514. The pre-sensing operation may include a coarse sensing estimation with low resource usage overhead. Additionally, or alternatively, the pre-sensing operation may include a fine sensing estimation performance within a short duration. In some implementations, the pre-sensing operation includes a monostatic sensing operation.

The network entity 450 may select the mobile base station 430 from the set of mobile base stations (e.g., one or more base stations) based on the received response information from the set of mobile base stations. For example, the network entity 450 based on an area or location of interest, such as an area or location of UE 115, mobile base station 430, an object (e.g., 490), or a combination thereof. In some implementations, the area or location of interest may be determined based on the request, at 502 or 506, the response information, target information (e.g., 466), mobile base station information (e.g., 468), or a combination thereof.

At 514, based on selection of mobile base station, network entity transmits configuration information 514. For example, the configuration information may include or correspond to configuration information 494. In some implementations, the selection of mobile base station 430 by network entity 450 may be transparent to UE 115. For example, when UE 115 is configured as an Rx node for the sensing operation, UE 115 may not need to know the configuration information, location of mobile base station 430, or a combination thereof. In other implementations, UE 115 may be informed of or receive the configuration information, at 514. For example, the configuration information received by UE 115 may include or indicate one or more sensing parameters, a Tx node configuration, an Rx node configuration, a location of mobile base station 430, a mobility of mobile base station 430, or a combination thereof. UE 115 may use the configuration to configure UE 115, calibrate UE 115, perform a sensing operation, or a combination thereof.

At 516, mobile base station 430 transmits a sensing signal. UE 115 may receive the sensing signal, such as a reflection of the sensing signal that is reflected off of an object (e.g. 490). UE 115 may determine sensing information 406 based on the received sensing signal.

At 506, UE 115 transmits a measurement report. For example, the measurement report may be based on the sensing signal, at 516, or include or correspond to report 495. In some implementations, UE 115 may send the measurement report that includes a compressed format of the sensing signal received by UE 115 at 516.

In some implementations, network entity 450 may receive the measurement report, at 518, and determine or identify one or more objects or targets based on the received measurement information. In some implementations, network entity 450 may determine target information, such as a target parameter, that indicates a position, a velocity, or a combination thereof of a detected target. For example, the target information may include or correspond to target information 466. Network entity 450 may transmit the target information to UE 115, another UE, mobile base station 430, core network 130 (e.g., a management function of core network 130), a base station (e.g., 105), or a combination thereof. In some implementations, UE 115 may receive target information, such as target information 466. Additionally, or alternatively, mobile base station 430 may receive the target information.

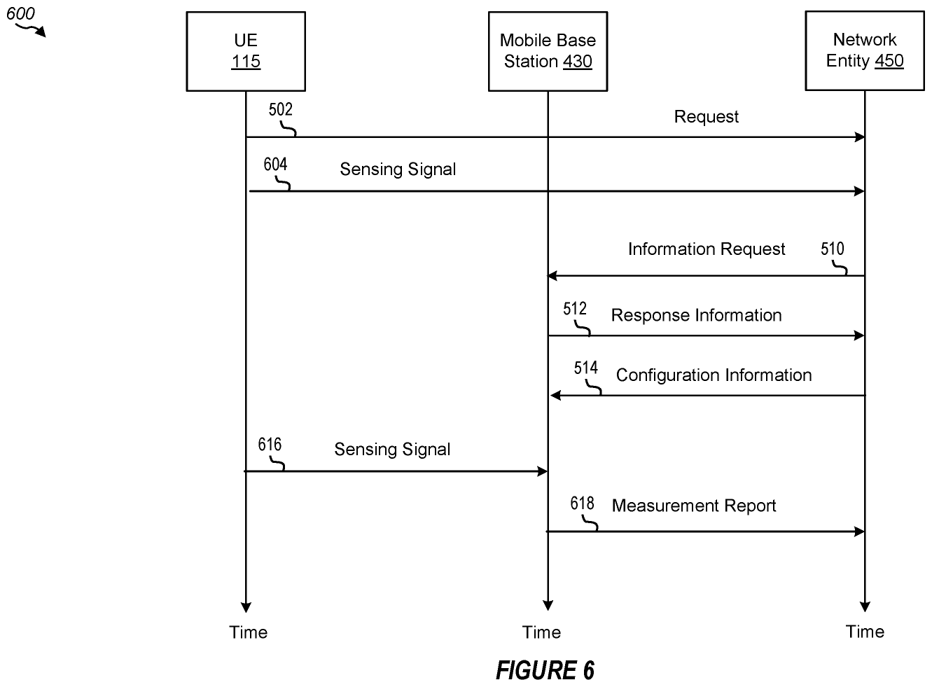

FIG. 6 is ladder diagram illustrating an example of a sensing operation according to aspects of the present disclosure. As shown in FIG. 6, a wireless communication system 600 of the ladder diagram of FIG. 6 includes UE 115, mobile base station 430, and network entity 450. Wireless communication system 600 may include or correspond to wireless communication system 100, 400, or 500. While FIG. 6 depicts singular mobile base station 430, wireless communication system 600 may include multiple mobile base stations. Additionally, although wireless communication system 600 does not show an object, (e.g., 490), in other implementation, wireless communication system 600 may include one or more objects. In some implementations, one or more operations performed or descried with respect to network entity may be performed by a controller, such as a centralized controller (e.g., core network 130 or a management function of core network).

During operation of system 600, at 502, UE 115 transmits a request to perform a sensing operation to network entity 450. In some implementations, network entity 450 is a base station (e.g., a fixed base station). For example, the request may include or correspond to sensing request 491. In some implementation, the request may request network entity 450 to assist in a bistatic sensing operation in which UE 115 is a Tx node. Additionally, or alternatively, the request may request network entity 450 to participate in the sensing operation as an Rx node. In some implementation, the request may include a parameter, such as a sensing KPI, a QoS requirement, or a combination thereof. The parameter may include or correspond to sensing parameter 464.

Based on the request, network entity 450 may grant one or more resources for performing the sensing operation. In some implementations, to grant the one or more resource, network entity 450 may generate or transmit configuration information to UE 115. The configuration information may include or correspond to configuration information 408 or 494.

At 604, UE 115 transmits a sensing signal. The network entity 450 may receive the sensing signal, such as a reflection of the sensing signal that is reflected off of an object (e.g. 490). Network entity 450 may determine sensing information 406 based on the received sensing signal.

Network entity 450 may determine, based on the received sensing signal, to select a mobile base station to assist UE 115 in performing a sensing operation. For example, network entity 450 may determine to select the mobile base station if the sensing signal at 604 is not received during a time period. Alternatively, network entity 450 may determine to select the mobile base station if the sensing signal at 604 is insufficient for target detection, insufficient for target estimation, does not satisfy the parameter, or a combination thereof.

In some implementation, network entity 450 selects mobile base station 430 from a set of multiple base stations. To select mobile base station 430 from the set of multiple base stations, network entity 450 may probe the set of mobile base stations. For example, network entity 450 probe the set of mobile base stations in response to receiving the request or may have previously provided the set of mobile base stations prior to receiving the request at 506.

To probe the set of mobile base stations, such as mobile base station 430, network entity 450 transmits an information request at 510. At 512, mobile base station 430 transmits response information 512. For example, the response information may include or correspond to response information 493, mobile base station information 468, or a combination thereof. Mobile base station 430 may transmit the response information in response to the information request. The response information may include or indicate a capability of mobile base station 430, a location of mobile base station 430, a mobility (e.g., one or more mobility parameters) of mobile base station 430, sensing charge information (sensing charging fec/rules) of mobile base station 430, a sensing measurement rereport of a pre-sensing operation by the mobile base station 430, or a combination thereof. The response information, at 512, may be transmitted to UE 115, network entity 450, or a combination thereof.

In some implementations, prior to or in response to receiving the information request, mobile base station 430 may perform a pre-sensing operation, such a pre-sensing operation to determine information associated with the response information, a suitability of the mobile base station 430 for use in a sensing operation (e.g., a bistatic sensing operation), or a combination thereof. To illustrate, pre-sensing operation may be performed using a channel associated with UE 115 and network entity 450 for the sensing signal at 504. In some implementations, the pre-sensing operation may monitor for the sensing signal at 514. The pre-sensing operation may include a coarse sensing estimation with low resource usage overhead. Additionally, or alternatively, the pre-sensing operation may include a fine sensing estimation performance within a short duration. In some implementations, the pre-sensing operation includes a monostatic sensing operation.

The network entity 450 may select the mobile base station 430 from the set of mobile base stations (e.g., one or more base stations) based on the received response information from the set of mobile base stations. For example, the network entity 450 based on an area or location of interest, such as an area or location of UE 115, mobile base station 430, an object (e.g., 490), or a combination thereof. In some implementations, the area or location of interest may be determined based on the request, at 502 or 506, the response information, target information (e.g., 466), mobile base station information (e.g., 468), or a combination thereof.

At 514, based on selection of mobile base station, network entity transmits configuration information 514. For example, the configuration information may include or correspond to configuration information 494. In some implementations, the selection of mobile base station 430 by network entity 450 may be transparent to UE 115. For example, when UE 115 is configured as an Tx node for the sensing operation, UE 115 may not need to know where an Rx node of the sensing operation is located. To illustrate, Rx processing of a sensing signal transmitted by the Tx node may be performed at the Rx node (e.g., mobile base station 430) based on Tx waveform or beam information, a position of UE 115, a velocity of UE 115, or a combination thereof. The Tx waveform or beam information, a position of UE 115, a velocity of UE 115, or a combination thereof, may be provided to mobile base station by network entity. Additionally, or alternatively, network entity 450 may be configured to perform Rx processing of the sensing signal transmitted by the Tx node based on sensing information received from UE 115 and mobile base station 430. In other implementations, UE 115 may be informed of or receive the configuration information, at 514. For example, the configuration information received by UE 115 may include or indicate one or more sensing parameters, a Tx node configuration, an Rx node configuration, a location of mobile base station 430, a mobility of mobile base station 430, or a combination thereof. UE 115 may use the configuration to configure UE 115, calibrate UE 115, perform a sensing operation, or a combination thereof.

At 616, UE 115 transmits a sensing signal. Mobile base station 430 may receive the sensing signal, such as a reflection of the sensing signal that is reflected off of an object (e.g. 490). Mobile base station 430 may determine sensing information 484 based on the received sensing signal.

At 618, mobile base station 430 transmits a measurement report. For example, the measurement report may be based on the sensing signal, at 516, or include or correspond to report 495. In some implementations, mobile base station 430 may send the measurement report that includes a compressed format of the sensing signal received by mobile base station 430 at 516.

In some implementations, network entity 450 may receive the measurement report, at 618, and determine or identify one or more objects or targets based on the received measurement information. In some implementations, network entity 450 may determine target information, such as a target parameter, that indicates a position, a velocity, or a combination thereof of a detected target. For example, the target information may include or correspond to target information 466. Network entity 450 may transmit the target information to UE 115, another UE, mobile base station 430, core network 130 (e.g., a management function of core network 130), a base station (e.g., 105), or a combination thereof.

Referring to the sensing operations described with reference to FIG. 5 and FIG. 6, it is noted that one or more operations described with reference to FIG. 5 or 6 may be combined or replaced with one or more operations described with the other of FIG. 5 or 6. For example, with reference to FIG. 5, the sensing signal at 504 may be transmitted by UE 115 rather than network entity 450, and measurement report and request at 506 may be omitted from FIG. 5. As another example, with reference to FIG. 5, the sensing signal at 516 may be transmitted by UE 116 and measurement report 518 may be transmitted by mobile base station 430. As another example, with reference to FIG. 6, sensing signal at 616 may transmitted by mobile base station 430 and measurement report 618 may be transmitted by UE 115. As another example, with reference to FIG. 5, UE 115 or mobile base station 430 may transmit the request at 502 which prompts network entity 450 to transmit the information request at 510. In some such implementations, the sensing signal at 504 and the measurement report and request at 506 may be omitted.

Referring to the sensing operations described with reference to FIG. 5 and FIG. 6, in some implementations, network entity 450 may select a set of base stations to assist UE 115 with a sensing operation. The set of base stations may include at least one mobile base station, such as mobile base station 430. In some implementations, the set of base stations also may include at least one fixed (e.g., stationary) base station. The set of base stations may be selected for a time period. For example, the set of base stations may be selected to perform a sensing operation during a time period. In some implementations, the set of base stations may be selected and configured as Rx nodes for the sensing operation. Additionally, or alternatively, a first portion of the set of base stations may be selected for a first time period and a second portion of the set of base stations may be selected for a second time period.

In some implementations, the set of base stations may be selected to scan for a sensing signal. For example, each base station of the set of base stations may be selected and configured to scan in a different beam direction, for a different scanning duration, or a combination thereof. Additionally, for each beam direction, resources may be allocated or assigned by network entity 450 for the set of base stations. The resources may be allocated or assigned for use and may have a start time, an end time, or a combination thereof. Alternatively, implementations, the set of base stations may be selected to track one or more targets. For example, the set of base stations may be selected and configured for concurrently tracking targets in multiple directions.

FIG. 7 is a flow diagram illustrating an example process 700 that supports a sensing operation according to one or more aspects. Operations of process 700 may be performed by a UE, such as UE 115 described above with reference to FIGS. 1-4 or a UE described with reference to FIG. 8. For example, example operations (also referred to as “blocks”) of process 700 may enable UE 115 to support a sensing operation, such as a sensing operation performed with a mobile base station.

In block 702, the UE receives, from a network entity, configuration information for a first sensing operation associated with a mobile base station. For example, the network entity and the mobile base station may include or correspond to network entity 450 and mobile base station 430, respectively. In some implementations, the network entity includes a network or a base station. The configuration information may include or correspond to configuration information 408 or 494, or mobile base station information 468. The configuration information may include or indicate a location of the mobile base station, mobility information of the mobile base station, or a combination thereof. Additionally, or alternatively, the configuration information may include or indicate that the UE is to perform the first scanning operation to: scan in a direction for a scan duration, or track a target in a direction. The target may include or correspond to object 490.

In block 704, the UE performs the first sensing operation with the mobile base station. In some implementations, the first sensing operation is or includes a bistatic sensing operation. Additionally, or alternatively, the UE may be configured as a Tx node or an Rx node for the first sensing operation.

In some implementations, after performance of the first sensing operation, the UE generates a report based on the first sensing operation. The report may include or correspond to report 495. The UE may transmit the report to the network entity, the mobile base station, or both. In some implementations, the report has a compressed format.

In some implementations, the UE transmits, to the network entity, a first sensing request for the first sensing operation. In some implementations, the configuration information is received based on the first sensing request. The first sensing request may include or correspond to modified sensing request 492. The first sensing request indicates a parameter. The parameter may include or correspond to sensing information 406, 462, or 484, or sensing parameter 464. In some implementations, the parameter includes or indicates a key performance indicator, a quality of service, or a combination thereof. The key performance indicator may include range coverage, field of view, range resolution, angular resolution, velocity resolution, accuracy, probability of detection, latency, refresh rate, number of simultaneous targets, or a combination thereof, as illustrative, non-limiting examples.

In some implementations, the UE receives target information associated with a target detected based on the first sensing operation. For example, the target may include or correspond to object 490. The target information may include or correspond to target information 466. The target information may include or indicate a position of the target, a velocity of the target, or a combination thereof.

In some implementations, prior to transmission of the first sensing request associated with the first sensing operation, the UE transmits a second sensing request to the network entity to assist the UE with a second sensing operation. For example, the second sensing request may include or correspond to sensing request 491. The UE may perform the second sensing operation with the network entity, such as network entity 450. Based on performance of the second sensing operation performed with the network entity, the UE may transmit a report, the first sensing request (e.g., modified sensing request 492), or a combination thereof. The report may include or correspond to report 495.

In some implementations, the UE performs the second sensing operation with the network entity. The UE may transmit a second report based on performance of the second sensing operation, the first sensing request, or a combination thereof. The second report may include or correspond to report 495, and the first sensing request may include or correspond to modified sensing request 492. In some implementations, the UE may transmit the second report or the first sensing request after a time period (during which the UE expected to receive a sensing signal of the second sensing operation), based on insufficient reception of a sensing signal by the UE, or a combination thereof.

FIG. 8 is a block diagram of an example UE 800 that supports a sensing operation according to one or more aspects. UE 800 may be configured to perform operations, including the blocks of a process described with reference to FIG. 7. In some implementations, UE 800 includes the structure, hardware, and components shown and described with reference to UE 115 of FIGS. 1-4. For example, UE 800 includes controller 280, which operates to execute logic or computer instructions stored in memory 282, as well as controlling the components of UE 800 that provide the features and functionality of UE 800. UE 800, under control of controller 280, transmits and receives signals via wireless radios 801a-r and antennas 252a-r. Wireless radios 801a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include sensing logic 802 and communication logic 803. Sensing logic 802 may be configured to enable UE 800 to perform a sensing operation, such as a bistatic sensing operation. Communication logic 803 may be configured to enable communication between UE 800 and one or more other devices. UE 800 may receive signals from or transmit signals to one or more network entities, such as base station 105 of FIGS. 1-4, mobile base station 430, network entity 450, or a base station as illustrated in FIG. 11.

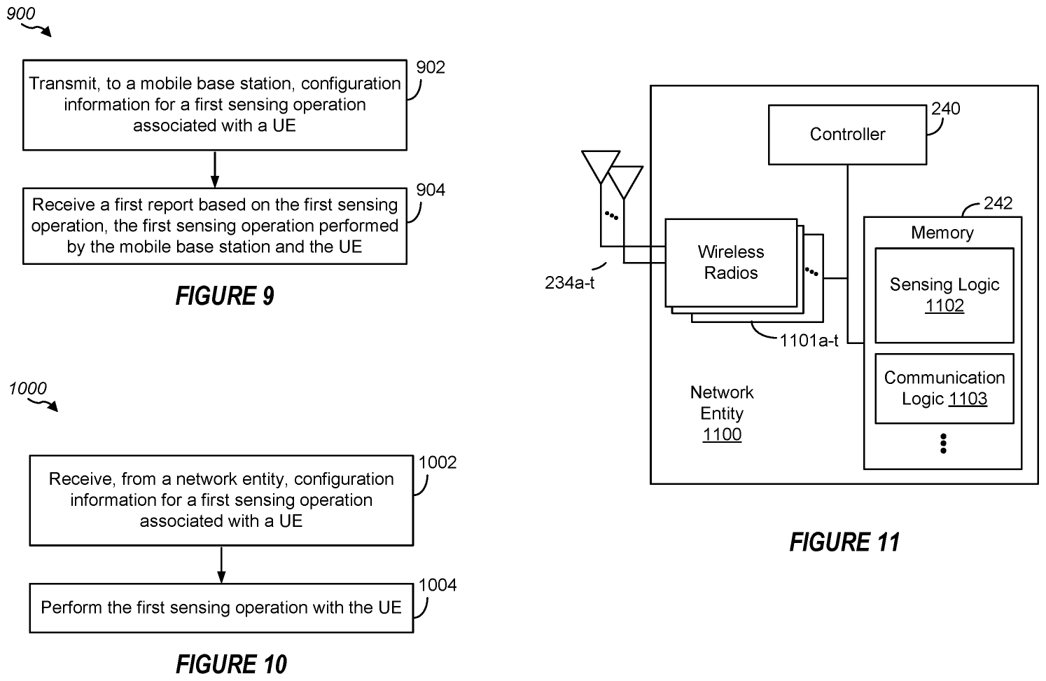

FIG. 9 is a flow diagram illustrating an example process 700 that supports a sensing operation according to one or more aspects. Operations of process 700 may be performed by a network entity, such as base station 105 described above with reference to FIGS. 1-3, a network (e.g., core network 130), network entity 450, or a network entity as described with reference to FIG. 11. For example, example operations of process 900 may enable the network entity to support a sensing operation.

At block 902, the network entity transmits, to a mobile base station, configuration information for a first sensing operation associated with a UE. For example, the UE and the mobile base station may include or correspond to UE 115 and mobile base station 430, respectively. The configuration information may include or correspond to configuration information 494. In some implementations, the first sensing operation is or includes a bistatic sensing operation.

At block 904, the network entity receives a first report based on the first sensing operation. For example, the first report may include or correspond to report 495. The first report may be received from the UE or the mobile base station. In some implementations, the first report has a compressed format The first sensing operation may be performed by the mobile base station and the UE. The UE may be as a Tx node or an Rx for the first sensing operation.

In some implementations, the network entity receives a first sensing request for the first sensing operation from the UE or the mobile base station. The first sending request may include or correspond to modified sensing request 492. The first sensing request may include or indicate a parameter. The parameter may include or correspond to sensing information 406, 462 or 484, or sensing parameter 464. In some implementations, the parameter includes or indicates a key performance indicator, a quality of service, or a combination thereof. The key performance indicator may include range coverage, field of view, range resolution, angular resolution, velocity resolution, accuracy, probability of detection, latency, refresh rate, number of simultaneous targets, or a combination thereof, as illustrative, non-limiting examples.

In some implementations, based on the first sensing request, the network entity may select the mobile base station from a set of mobile base stations. For example, the network entity may select the mobile base station based on or in response to the first sensing request received from the UE. To illustrate, to select the mobile base station, the network entity transmitting an information request based on or in response to the first sensing request. The information request may include or correspond to may include or correspond to a request transmitted from network entity 450 to mobile base station 430. The network entity may receive, from each mobile base station of one or more mobile base stations and based on the information request, response information. The response information may include or correspond to response information 493 or mobile base station information 468. The response information may include or indicate a capability of the mobile base station, location of the mobile base station, a mobility of the mobile base station, sensing charge information of the mobile base station, a sensing measurement report of a pre-sensing operation by the mobile base station, or a combination thereof. The network entity may select the mobile base station from the one or more mobile base stations based on the response information received from the one or more mobile base stations, an area of interest, or a combination thereof. The area of interest may be included in or indicated by the first sensing request. The configuration information may be transmitted to the mobile base station based on selection of the mobile base station.

In some implementations, prior to transmitting the configuration information to the mobile base station or prior to receiving the first sensing request, the network entity receives, from the UE, a second sensing request to assist the UE with a second sensing operation. For example, the second sensing request may include or correspond to sensing request 491. The network entity may perform the second sensing operation with the UE. The UE may be configured to be a Tx node or an Rx node to perform the second sensing operation. Based on performance of the second sensing operation performed between the network entity and the UE, the network entity may determine a sensing result of the second sensing operation. For example, the network entity may determine the sensing result when the UE is configured to be a Tx node to perform the second sensing operations. Alternatively, based on performance of the second sensing operation performed between the network entity and the UE, the network entity may receive, from the UE, a second report (e.g., 495), a first sensing request (e.g., 492), or a combination thereof. In some implementations, the network entity may transmit an information request (e.g., to request response information 493) based on the sensing result, the second report, or the first sensing request.

In some implementations, to perform the second sensing operation with the UE, the network entity transmitting a sensing signal. The network entity may receive a second report based on performance of the second sensing operation, a first sensing request for the first sensing operation, or a combination thereof. In some implementations, the network entity may receive, from the UE, the second report or the first sensing request after a time period (during which the UE expected to receive a sensing signal of the second sensing operation), based on insufficient reception of a sensing signal by the UE, or a combination thereof.

In some implementations, the network entity transmits, to the UE, the configuration information, a location of the mobile base station, mobility information of the mobile base station, or a combination thereof. For example, the UE may transmit the configuration information based on or in response to the first sensing request or the second sensing request. Additionally, or alternatively, after receipt of the first report, the network entity may transmit target information associated with a target detected based on the first report. For example, the target and the target information may include or correspond to object 490 and target information 466, respectively. The target information may include or indicate a position of the target, a velocity of the target, or a combination thereof.

In some implementations, the network entity performs, in association with the first sensing operation, a handover operation of the mobile base station to another mobile base station. The handover operation may be performed based on a location of the mobile base station or the other mobile base station, a mobility of the mobile base station or the other mobile base station, the first report, or a combination thereof.

In some implementations, the network entity selects a set of mobile base stations of one or more mobile base stations for performing the first scanning operation. The set of mobile base stations may include the mobile base station. Additionally, or alternatively, each mobile base station of the set of mobile base stations is selected to scan in a direction for a scan duration, or the set of mobile base stations is selected to track multiple targets in multiple directions.

FIG. 10 is a flow diagram illustrating an example process 1000 that supports a sensing operation according to one or more aspects. Operations of process 1000 may be performed by a mobile base station, such as mobile base station 430, or a network entity as described with reference to FIG. 11. For example, example operations of process 1000 may enable the mobile base station to support a sensing operation.

At block 1002, the mobile base station receives, from a network entity, configuration information for a first sensing operation associated with a UE. For example, the network entity and the UE may include or correspond to network entity 450 and UE 115, respectively. In some implementations, the network entity includes a network or a base station, such as base station 105. The configuration information may include or correspond to configuration information 494. In some implementations, the configuration information indicates the mobile base station is to perform the first scanning operation to: scan in a direction for a scan duration, or track a target in a direction.

At block 1004, the mobile base station performs the first sensing operation with the UE. The first sensing operation may be or may include a bistatic sensing operation. In some implementations, to perform the first sensing operation, the UE is configured as a Tx node or an Rx node. In some implementations, the mobile base station generates a first report based on the first sensing operation. The first report may include or correspond to report 495. The mobile base station may transmit the first report to the network entity. In some implementations, during or after performance of the first sensing operation, the mobile base station may participate in a handover operation.

In some implementations, the mobile base station transmit a sensing request for the first sensing operation. The sensing request may include or correspond to sensing request 491 or modified sensing request 492. The sensing request indicates parameters, the parameter includes a key performance indicator, a quality of service, or a combination thereof.

In some implementations, the mobile base station receives an information request from the network entity. The mobile base station may transmit, based on the information request, response information. For example, the response information may include or correspond to response information 493. The response information may include or indicate a capability of the mobile base station, location of the mobile base station, a mobility of the mobile base station, sensing charge information of the mobile base station, a sensing measurement report of a pre-sensing operation by the mobile base station, or a combination thereof. Based on the information request, the mobile base station may perform a pre-scan operation that includes a course sensing estimation of a channel, a fine sensing estimation of the channel, or a combination thereof. In some implementations, the pre-scan operation includes a monostatic scanning operation or a bistatic sensing operation. Additionally or alternatively, the information request may indicate the channel. The mobile base station may transmit a pre-scan report based on a result of the pre-scan operation.

In some implementations, after performance of the first sensing operation, the mobile base station receives, from the network entity, target information associated with a target detected based on the first sensing operation. The target information may include or correspond to target information 466. The target information may include or indicate a position of the target, a velocity of the target, or a combination thereof. The target may include or correspond to object 490.

FIG. 11 is a block diagram of an example network entity 1100 that supports a sensing operation according to one or more aspects. Network entity 1100 may be configured to perform operations, including the blocks of process 900 or 1000 described above. In some implementations, network entity 1100 includes the structure, hardware, and components shown and described with reference to base station 105 of FIGS. 1-4. For example, network entity 1100 may include controller 240, which operates to execute logic or computer instructions stored in memory 242, as well as controlling the components of network entity 1100 that provide the features and functionality of network entity 1100. Network entity 1100, under control of controller 240, transmits and receives signals via wireless radios 1101a-t and antennas 234a-t. Wireless radios 1101a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include sensing logic 1102 and communication logic 1103. Sensing logic 1102 may be configured to enable network entity 1100 to perform one or more sensing operations, such a monostatic sensing operation or a bistatic sensing operation. Communication logic 1103 may be configured to enable communication between network entity 1100 and one or more other devices. Network entity 1100 may receive signals from or transmit signals to one or more UEs, such as UE 115 of FIGS. 1-4 or UE 800 of FIG. 8.

It is noted that one or more blocks (or operations) described with reference to FIG. 7, 9, or 10 may be combined with one or more blocks (or operations) described with reference to another of the figures. For example, one or more blocks (or operations) of FIG. 7 may be combined with one or more blocks (or operations) of FIG. 9. As another example, one or more blocks associated with FIG. 7 may be combined with one or more blocks associated with FIG. 10. As another example, one or more blocks associated with FIG. 9 may be combined with one or more blocks associated with FIG. 10. As another example, one or more blocks associated with FIG. 7, 9, or 10 may be combined with one or more blocks (or operations) associated with FIGS. 1-4. As another example, one or more blocks associated with FIG. 7, 9, or 10 may be combined with one or more or operations associated with FIG. 5 or 6. Additionally, or alternatively, one or more operations described above with reference to FIGS. 1-4 may be combined with one or more operations described with reference to FIG. 8 or 11.
In one or more aspects, techniques for supporting a sensing operation may include additional aspects, such as any single aspect or any combination of aspects described below or in connection with one or more other processes or devices described elsewhere herein. In a first aspect, techniques for supporting a sensing operation may include receiving, from a network entity, configuration information for a first sensing operation associated with a mobile base station. The techniques may further include performing the first sensing operation with the mobile base station. In some examples, the techniques in the first aspect may be implemented in a method or process. In some other examples, the techniques of the first aspect may be implemented in a wireless communication device, which may include a UE or a component of a UE. For example, the techniques may include or correspond to a method of wireless communication performed by a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.
In a second aspect, in combination with the first aspect, the techniques further include transmitting, to the network entity, a first sensing request for the first sensing operation.
In a third aspect, in combination with the first aspect or the second aspect, the first sensing request indicates a parameter.
In a fourth aspect, in combination with one or more of the first aspect through the third aspect, the parameter includes a key performance indicator, a quality of service, or a combination thereof.
In a fifth aspect in combination with one or more of the first aspect through the fourth aspect, the configuration information is received based on the first sensing request.
In a sixth aspect, in combination with one or more of the first aspect through the fifth aspect, the network entity includes a network or a base station.
In a seventh aspect, in combination with one or more of the first aspect through the sixth aspect, the first sensing operation is a bistatic sensing operation.
In an eighth aspect, in combination with one or more of the first aspect through the seventh aspect, the UE is configured as a Tx node or an Rx node for the first sensing operation.
In a ninth aspect, in combination with one or more of the first aspect through the eighth aspect, the configuration information indicates a location of the mobile base station, mobility information of the mobile base station, or a combination thereof.
In a tenth aspect, in combination with one or more of the first aspect through the ninth aspect, the techniques further include receiving target information associated with a target detected based on the first sensing operation.
In an eleventh aspect, in combination with the tenth aspect, the target information indicates a position of the target, a velocity of the target, or a combination thereof.
In a twelfth aspect, in combination with one or more of the first aspect through the eleventh aspect, the configuration information indicates the UE is to perform the first scanning operation to scan in a direction for a scan duration.
In a thirteenth aspect, in combination with one or more of the first aspect through the eleventh aspect, the configuration information indicates the UE is to perform the first scanning operation to track a target in a direction.
In a fourteenth aspect, in combination with one or more of the first aspect through the thirteenth aspect, the techniques further include, prior to transmitting a first sensing request associated with the first sensing operation, transmitting a second sensing request to the network entity to assist the UE with a second sensing operation.
In a fifteenth aspect, in combination with the fourteenth aspect, the techniques further include performing the second sensing operation with the network entity.
In a sixteenth aspect, in combination with the sixteenth aspect, the techniques further include, based on performance of the second sensing operation performed with the network entity, transmitting a report, the first sensing request, or a combination thereof.
In a seventeenth aspect, in combination with the sixteenth aspect, a second report based on performance of the second sensing operation, the first sensing request, or a combination thereof, is transmitted to the network entity after at least a first time period.
In an eighteenth aspect, in combination with the sixteenth aspect, a second report based on performance of the second sensing operation, the first sensing request, or a combination thereof, is transmitted to the network entity based on insufficient reception of a sensing signal by the UE.
In a nineteenth aspect, in combination with one or more of the first aspect through the eighteenth aspect, the techniques further include, after performance of the first sensing operation, generating a report based on the first sensing operation.
In a twentieth aspect, in combination with the nineteenth aspect, the techniques further include, after performance of the first sensing operation, transmitting the report to the network entity.
In a twenty-first aspect, in combination with one or more of the first aspect through the twentieth aspect, the report has a compressed format.

In one or more aspects, techniques for supporting a sensing operation may include additional aspects, such as any single aspect or any combination of aspects described below or in connection with one or more other processes or devices described elsewhere herein. In a twenty-second aspect, techniques for supporting a sensing operation may include transmitting, to a mobile base station, configuration information for a first sensing operation associated with a UE. The techniques may further include receiving a first report based on the first sensing operation, the first sensing operation performed by the mobile base station and the UE. In some examples, the techniques in the twenty-second aspect may be implemented in a method or process. In some other examples, the techniques of the twenty-second aspect may be implemented in a wireless communication device, such as network entity, which may include a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.
In a twenty-third aspect, in combination with the twenty-second aspect, the network entity includes a network or a base station.
In a twenty-fourth aspect, in combination with the twenty-second aspect or the twenty-third aspect, the first sensing operation is a bistatic sensing operation.
In a twenty-fifth aspect, in combination with one or more of the twenty-second aspect through the twenty-fourth aspect, the UE is configured as a Tx node or an Rx node for the first sensing operation.
In a twenty-sixth aspect, in combination with one or more of the twenty-second aspect through the twenty-fifth aspect, the first report is received from the mobile base station or the UE.
In a twenty-seventh aspect, in combination with one or more of the twenty-second aspect through the twenty-sixth aspect, the first report has a compressed format.
In a twenty-eighth aspect, in combination with one or more of the twenty-second aspect through the twenty-seventh aspect, the techniques further include receiving a first sensing request for the first sensing operation from the UE or the mobile base station.
In a twenty-ninth aspect, in combination with the twenty-eighth aspect, the techniques further include, based on the first sensing request, selecting the mobile base station from a set of mobile base stations.
In a thirtieth aspect, in combination with the twenty-ninth aspect, the first sensing request indicates parameters, the parameter includes a key performance indicator, a quality of service, or a combination thereof.
In a thirty-first aspect, in combination with the twenty-ninth aspect, the techniques further include, based on the first sensing request, transmitting an information request.
In a thirty-second aspect, in combination with the thirty-first aspect, the techniques further include receiving, from each mobile base station of one or more mobile base stations and based on the information request, response information that indicates a capability of the mobile base station, location of the mobile base station, a mobility of the mobile base station, sensing charge information of the mobile base station, a sensing measurement rereport of a pre-sensing operation by the mobile base station, or a combination thereof.
In a thirty-third aspect, in combination with the thirty-second aspect, the techniques further include selecting the mobile base station from the one or more mobile base stations based on the response information received from the one or more mobile base station, an area of interest, or a combination thereof.
In a thirty-fourth aspect, in combination with the thirty-third aspect, the configuration information is transmitted to the mobile base station based on selection of the mobile base station.
In a thirty-fifth aspect, in combination with one or more of the twenty-second aspect through the thirty-fourth aspect, the techniques further include, prior to transmitting the configuration information to the mobile base station, receiving, from the UE, a second sensing request to assist the UE with a second sensing operation.
In a thirty-sixth aspect, in combination with the thirty-fifth aspect, the techniques further include performing the second sensing operation with the UE.
In a thirty-seventh aspect, in combination with the thirty-sixth aspect, the techniques further include, based on performance of the second sensing operation performed between the network entity and the UE, determining a sensing result.
In a thirty-eighth aspect, in combination with the thirty-seventh aspect, the techniques further include, based on performance of the second sensing operation performed between the network entity and the UE, receiving, from the UE, a second report, a first sensing request, or a combination thereof.
In a thirty-ninth aspect, in combination with the thirty-seventh aspect or the thirty-eighth aspect, the techniques further include transmitting an information request based on the sensing result, the second report, or the first sensing request.
In a thirty-seventh aspect, in combination with the thirty-sixth aspect, performing the second sensing operation with the UE includes transmitting a sensing signal.
In a forty-first aspect, in combination with the fortieth aspect, a second report based on performance of the second sensing operation, a first sensing request for the first sensing operation, or a combination thereof, is received from the UE after at least a first time period, based on insufficient reception of the sensing signal by the UE, or a combination thereof.
In a forty-second aspect, in combination with one or more of the twenty-second aspect through the forty-first aspect, the techniques further include transmitting, to the UE, the configuration information, a location of the mobile base station, mobility information of the mobile base station, or a combination thereof.
In a forty-third aspect, in combination with the forty-second aspect, the techniques further include, after receipt of the first report, transmitting target information associated with a target detected based on the first report.
In a forty-fourth aspect, in combination with the forty-third aspect, the target information indicates a position of the target, a velocity of the target, or a combination thereof.
In a forty-fifth aspect, in combination with one or more of the first aspect through the forty-fourth aspect, the techniques further include performing, in association with the first sensing operation, a handover operation of the mobile base station to another mobile base station.
In a forty-sixth aspect, in combination with the forty-fifth aspect, wherein the handover operation is performed based on a location of the mobile base station or the other mobile base station, a mobility of the mobile base station or the other mobile base station, the first report, or a combination thereof.
In a forty-seventh aspect, in combination with one or more of the first aspect through the forty-sixth aspect, the techniques further include selecting a set of mobile base stations of one or more mobile base stations for performing the first scanning operation, the set of mobile base stations including the mobile base station.
In a forty-eighth aspect, in combination with the forty-seventh aspect, each mobile base station of the set of mobile base stations is selected to scan in a direction for a scan duration.
In a forty-ninth aspect, in combination with the forty-seventh aspect, the set of mobile base stations is selected to track multiple targets in multiple directions.

In one or more aspects, techniques for supporting a sensing operation may include additional aspects, such as any single aspect or any combination of aspects described below or in connection with one or more other processes or devices described elsewhere herein. In a fiftieth aspect, techniques for supporting a sensing operation may include receiving, from a network entity, configuration information for a first sensing operation associated with a UE. The techniques may further include performing the first sensing operation with the UE. In some examples, the techniques in the fiftieth aspect may be implemented in a method or process. In some other examples, the techniques of the fiftieth aspect may be implemented in a wireless communication device, such as network entity, which may include a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.
In a fifty-first aspect, in combination with the fiftieth aspect, the network entity includes a network or a base station.
In a fifty-second aspect, in combination with the fiftieth aspect or the fifty-first aspect, the first sensing operation is a bistatic sensing operation.
In a fifty-third aspect, in combination with one or more of the fiftieth aspect through the fifty-second aspect, the UE is configured as a Tx node or an Rx for the first sensing operation.
In a fifty-fourth aspect, in combination with one or more of the fiftieth aspect through the fifty-third aspect, the techniques further include generating a first report based on the first sensing operation.
In a fifty-fifth aspect, in combination with the fifty-fourth aspect, the techniques further include transmitting the first report to the network entity.
In a fifty-sixth aspect, in combination with one or more of the fiftieth aspect through the fifty-fifth aspect, the techniques further include transmitting a first sensing request for the first sensing operation.
In a fifty-seventh aspect, in combination with the fifty-sixth aspect, the first sensing request indicates parameters, the parameter includes a key performance indicator, a quality of service, or a combination thereof.
In a fifty-eighth aspect, in combination with one or more of the fiftieth aspect through the fifty-seventh aspect, the techniques further include receiving an information request from the network entity.
In a fifty-ninth aspect, in combination with the fifty-eighth aspect, the techniques further include transmitting, based on the information request, response information that indicates a capability of the mobile base station, location of the mobile base station, a mobility of the mobile base station, sensing charge information of the mobile base station, a sensing measurement rereport of a pre-sensing operation by the mobile base station, or a combination thereof.
In a sixtieth aspect, in combination with the fifty-ninth aspect, the techniques further include, based on the information request, perform a pre-scan operation that includes a course sensing estimation of a channel, a fine sensing estimation of the channel, or a combination thereof.
In a sixty-first aspect, in combination with the sixtieth aspect, the information request indicates the channel.
In a sixty-second aspect, in combination with the sixty-first aspect, the techniques further include sending a pre-scan report based on a result of the pre-scan operation.
In a sixty-third aspect, in combination with the sixty-second aspect, the techniques further include, after performance of the first sending operation, receiving, from the network entity, target information associated with a target detected based on the first sensing operation.
In a sixty-fourth aspect, in combination with the sixty-third aspect, the target information indicates a position of the target, a velocity of the target, or a combination thereof.
In a sixty-fifth aspect, in combination with one or more of the fiftieth aspect through the sixty-fourth aspect, the techniques further include, during or after performance of the first sensing operation, participating in a handover operation.
In a sixty-sixth aspect, in combination with one or more of the fiftieth aspect through the sixty-fifth aspect, the configuration information indicates the mobile base station is to perform the first scanning operation to: scan in a direction for a scan duration.
In a sixty-seventh aspect, in combination with one or more of the fiftieth aspect through the sixty-fifth aspect, the configuration information indicates the mobile base station is to perform the first scanning operation to track a target in a direction.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A network entity comprising:
a memory storing processor-readable code; and
at least one processor coupled to the memory, the at least one processor configured to execute the processor-readable code to cause the at least one processor to:
transmit, to a mobile base station, configuration information for a first sensing operation associated with a user equipment (UE); and
receive a first report based on the first sensing operation, the first sensing operation performed by the mobile base station and the UE.

2. The network entity of claim 1, wherein:
the network entity includes a network or a base station,
the first sensing operation is a bistatic sensing operation,
the UE is configured as a transmit (Tx) node or a receive (Rx) node for the first sensing operation,
the first report is received from the mobile base station or the UE,
the first report has a compressed format, or
a combination thereof.

3. The network entity of claim 1, wherein the at least one processor is configured to execute the processor-readable code to cause the at least one processor to:
receive a first sensing request for the first sensing operation from the UE or the mobile base station; and
based on the first sensing request, select the mobile base station from a set of mobile base stations.

4. The network entity of claim 3, wherein the first sensing request indicates parameters, the parameter includes a key performance indicator, a quality of service, or a combination thereof.

5. The network entity of claim 3, wherein the at least one processor is configured to execute the processor-readable code to cause the at least one processor to:
based on the first sensing request, transmit an information request;
receive, from each mobile base station of one or more mobile base stations and based on the information request, response information that indicates a capability of the mobile base station, location of the mobile base station, a mobility of the mobile base station, sensing charge information of the mobile base station, a sensing measurement report of a pre-sensing operation by the mobile base station, or a combination thereof; and
select the mobile base station from the one or more mobile base stations based on the response information received from the one or more mobile base station, an area of interest, or a combination thereof,
wherein the configuration information is transmitted to the mobile base station based on selection of the mobile base station.

6. The network entity of claim 1, wherein the at least one processor is configured to execute the processor-readable code to cause the at least one processor to:
prior to transmission of the configuration information to the mobile base station, receive, from the UE, a second sensing request to assist the UE with a second sensing operation; and
perform the second sensing operation with the UE.

7. The network entity of claim 6, wherein the at least one processor is configured to execute the processor-readable code to cause the at least one processor to:
based on performance of the second sensing operation performed between the network entity and the UE:
determine a sensing result; or
receive, from the UE, a second report, a first sensing request, or a combination thereof; and
transmit an information request based on the sensing result, the second report, or the first sensing request.

8. The network entity of claim 6, wherein:
to perform the second sensing operation with the UE, wherein the at least one processor is configured to execute the processor-readable code to cause the at least one processor to transmit a sensing signal; and
a second report based on performance of the second sensing operation, a first sensing request for the first sensing operation, or a combination thereof, is received from the UE after at least a first time period, based on insufficient reception of the sensing signal by the UE, or a combination thereof.

9. The network entity of claim 1, wherein the at least one processor is configured to execute the processor-readable code to cause the at least one processor to:
transmit, to the UE, the configuration information, a location of the mobile base station, mobility information of the mobile base station, or a combination thereof; and
after receipt of the first report, transmit target information associated with a target detected based on the first report, the target information indicates a position of the target, a velocity of the target, or a combination thereof.

10. The network entity of claim 1, wherein the at least one processor is configured to execute the processor-readable code to cause the at least one processor to:
perform, in association with the first sensing operation, a handover operation of the mobile base station to another mobile base station, and
wherein the handover operation is performed based on a location of the mobile base station or the other mobile base station, a mobility of the mobile base station or the other mobile base station, the first report, or a combination thereof.

11. The network entity of claim 1, wherein the at least one processor is configured to execute the processor-readable code to cause the at least one processor to:
select a set of mobile base stations of one or more mobile base stations for performance of the first scanning operation, the set of mobile base stations including the mobile base station,
wherein:
each mobile base station of the set of mobile base stations is selected to scan in a direction for a scan duration, or
the set of mobile base stations is selected to track multiple targets in multiple directions.

12. A mobile base station comprising:
a memory storing processor-readable code; and
at least one processor coupled to the memory, the at least one processor configured to execute the processor-readable code to cause the at least one processor to:
receive, from a network entity, configuration information for a first sensing operation associated with a user equipment (UE); and
perform the first sensing operation with the UE.

13. The mobile base station of claim 12, wherein:
the network entity includes a network or a base station,
the first sensing operation is a bistatic sensing operation,
the UE is configured as a transmit (Tx) node or a receive (Rx) for the first sensing operation, or
a combination thereof.

14. The mobile base station of claim 13, wherein the at least one processor is configured to execute the processor-readable code to cause the at least one processor to:
generate a first report based on the first sensing operation; and
transmit the first report to the network entity.

15. The mobile base station of claim 12, wherein the at least one processor is configured to execute the processor-readable code to cause the at least one processor to:
transmit a first sensing request for the first sensing operation, and wherein the first sensing request indicates parameters, the parameter includes a key performance indicator, a quality of service, or a combination thereof.

16. The mobile base station of claim 12, wherein the at least one processor is configured to execute the processor-readable code to cause the at least one processor to:
receive an information request from the network entity; and
transmit, based on the information request, response information that indicates a capability of the mobile base station, location of the mobile base station, a mobility of the mobile base station, sensing charge information of the mobile base station, a sensing measurement report of a pre-sensing operation by the mobile base station, or a combination thereof.

17. The mobile base station of claim 16, wherein the at least one processor is configured to execute the processor-readable code to cause the at least one processor to:
based on the information request, perform a pre-scan operation that includes a course sensing estimation of a channel, a fine sensing estimation of the channel, or a combination thereof, wherein the information request indicates the channel; and
transmit a pre-scan report based on a result of the pre-scan operation.

18. The mobile base station of claim 12, wherein the at least one processor is configured to execute the processor-readable code to cause the at least one processor to:
after performance of the first sending operation, receive, from the network entity, target information associated with a target detected based on the first sensing operation,
wherein the target information indicates a position of the target, a velocity of the target, or a combination thereof.

19. The mobile base station of claim 12, wherein the at least one processor is configured to execute the processor-readable code to cause the at least one processor to:
during or after performance of the first sensing operation, participate in a handover operation.

20. The mobile base station of claim 12, wherein the configuration information indicates the mobile base station is to perform the first scanning operation to:
scan in a direction for a scan duration, or
track a target in a direction.

21. A user equipment (UE) comprising:
a memory storing processor-readable code; and
at least one processor coupled to the memory, the at least one processor configured to execute the processor-readable code to cause the at least one processor to:
receive, from a network entity, configuration information for a first sensing operation associated with a mobile base station; and
perform the first sensing operation with the mobile base station.

22. The UE of claim 21, wherein the at least one processor is configured to execute the processor-readable code to cause the at least one processor to:
transmit, to the network entity, a first sensing request for the first sensing operation, the first sensing request indicates a parameter, the parameter includes a key performance indicator, a quality of service, or a combination thereof, and
wherein:
the configuration information is received based on the first sensing request,
the network entity includes a network or a base station,
the first sensing operation is a bistatic sensing operation,
the UE is configured as a transmit (Tx) node or a receive (Rx) for the first sensing operation, or
a combination thereof.

23. The UE of claim 21, wherein the configuration information indicates a location of the mobile base station, mobility information of the mobile base station, or a combination thereof.

24. The UE of claim 21, wherein the at least one processor is configured to execute the processor-readable code to cause the at least one processor to:
receive target information associated with a target detected based on the first sensing operation, the target information indicates a position of the target, a velocity of the target, or a combination thereof.

25. The UE of claim 21, wherein the configuration information indicates the UE is to perform the first scanning operation to:
scan in a direction for a scan duration, or
track a target in a direction.

26. The UE of claim 21, wherein the at least one processor is configured to execute the processor-readable code to cause the at least one processor to:
prior to transmission of a first sensing request associated with the first sensing operation, transmit a second sensing request to the network entity to assist the UE with a second sensing operation; and
perform the second sensing operation with the network entity.

27. The UE of claim 26, wherein the at least one processor is configured to execute the processor-readable code to cause the at least one processor to:
based on performance of the second sensing operation performed with the network entity, transmit a report, the first sensing request, or a combination thereof.

28. The UE of claim 26, wherein:
the second sensing operation is performed with the network entity; and
a second report based on performance of the second sensing operation, the first sensing request, or a combination thereof, is transmitted to the network entity after at least a first time period, based on insufficient reception of a sensing signal by the UE, or a combination thereof.

29. The UE of claim 21, wherein the at least one processor is configured to execute the processor-readable code to cause the at least one processor to:
after performance of the first sensing operation:
generate a report based on the first sensing operation; and
transmit the report to the network entity.

30. The UE of claim 29, wherein the report has a compressed format.
